(19) United States
(12) Patent Application Publication
(10) Pub. No.: US 2009/0249284 A1
(43) Pub. Date: Oct. 1, 2009

(54) AUTOMATION FOR VIRTUALIZED IT ENVIRONMENTS

(75) Inventors: Waclaw T. Antosz, Woodinville, WA (US); Sergei Gringanze, Redmond, WA (US); Przemyslaw Pardyak, Seattle, WA (US); Dennis Richard Russell, Mill Creek, WA (US); Reid Andrew Spencer, Mercer Island, WA (US); Paul M. Sterley, Snohomish, WA (US); Ashutosh Tiwary, Mercer Island, WA (US); Moshe Vainer, Redmond, WA (US)

Correspondence Address: BLACK LOWE & GRAHAM, PLLC, 701 FIFTH AVENUE, SUITE 4800, SEATTLE, WA, 98104, US

(73) Assignee: Doyenz Incorporated, Bellevue, WA (US)

(21) Appl. No.: 12/396,353

(22) Filed: Mar. 2, 2009

Related U.S. Application Data
(60) Provisional application No. 61/032,524, filed on Feb. 29, 2008.
(60) Provisional application No. 61/101,951, filed on Oct. 1, 2008.

(51) Int. Cl. G06F 9/44; G06F 12/16

(52) U.S. Cl. 717/104; 717/126; 717/168; 711/162; 711/E12.103

(57) ABSTRACT

A system automatically builds custom virtual appliances and/or other computing environments and their components, where applicable, based on user requirements and may offer a service for hosting, maintaining, monitoring and managing such appliances remotely. These virtual appliances may be delivered over a network, such as the Internet, and can be run at a customer site or at a hosting provider. Some embodiments of the invention can build these appliances using custom applications developed by customers.

### PRIORITY CLAIM

This application claims priority to U.S. Provisional Application No. 61/032,524 filed on Feb. 29, 2008 entitled AUTOMATION FOR VIRTUALIZED IT ENVIRONMENTS and U.S. Provisional Application No. 61/101,951 filed on Oct. 1, 2008 entitled AUTOMATION FOR VIRTUALIZED IT ENVIRONMENTS, which are herein incorporated by reference in their entirety.

### BACKGROUND OF THE PREFERRED EMBODIMENT

In contemporary business environments, the employment of servers, desktops, networks, and other components of computer environments has become standard practice. As with other machinery, such computer environments periodically experience malfunction or, otherwise, require upgrading with new features or capabilities, or regular maintenance, reconfigurations, etc. In such instances, an information technology (IT) expert may be called in onsite to repair or otherwise upgrade computer environments. However, the need for such an expert may occur at a time at which the expert cannot possibly, or at least inexpensively, appear to provide the needed services. Additionally, any software used by the expert to remedy the situation may, without prior testing in an identical computer environment, prove incompatible or may otherwise worsen the situation. Such expert may not possess all the knowledge or experience or tools necessary for the task at hand. In addition, the cost of performing the tasks may be too costly, or too time consuming, or may not be performed at the time when it's most convenient.

### BRIEF DESCRIPTION OF THE DRAWINGS

Preferred and alternative embodiments of the present invention are described in detail below with reference to the following drawings.

FIG. 1 is a functional block diagram of functionality, processes and technology associated with a system 5 according to an embodiment of the invention;

FIG. 2 is an exemplary process flow according to an embodiment of the invention;

FIG. 3 is an exemplary process flow of a disaster-recovery approach according to an embodiment.

### DETAILED DESCRIPTION OF THE PREFERRED EMBODIMENT

For purposes of the description herein, some concepts upon which one or more embodiments are based are explained below.

Virtual Appliance

One or more embodiments employ virtual machine technology. As used herein, and generally speaking, a virtual machine (VM) is a software implementation of electronic hardware, such as a general-purpose computer, that executes software applications in a manner identical or similar to electronic hardware. One or more virtual machines running a guest operating system and one or more applications may form a virtual appliance. That is, a virtual appliance may be the combination of one or more virtual machine instances, guest operating systems running in the virtual machine instances, and one or more applications running within the virtual machines. A virtual appliance could also be a hardware device that implements all the functionality of a corresponding software virtual appliance. A virtual appliance has a configuration associated with it, including configuration of all or some of its components, as well as external configuration, such as for example networking or connectivity to other virtual appliances, virtual machines, or software running not virtualized or hardware. A virtual appliance is such a collection assembled and configured to perform one or many functions or tasks. A virtual environment is a collection of virtual appliances that form all or parts of an IT infrastructure. A virtual environment may be purely virtualized, i.e., all of its components are virtual appliances or it may be a hybrid, or a combination virtualized and non-virtualized components.

Image

In order to execute a single virtual machine there is generally a required set of information that preferably includes specification and configuration of the machine, virtual device descriptions, virtual hard disks, inter-connections between the virtual and real hardware for disks, networks, memory, CPU's, and other related information. Such a set of information may be referred to as an “image.” Such an image may be considered as any data needed, preferred or helpful to run a virtual machine.

Some processes that may be used in several of the functional descriptions below are as follows:

Image Viewing. Browsing or searching through or otherwise accessing an image directly with or without mounting it in a VM or executing the VM. In an embodiment, a graphical user interface (GUI) allows reviewing the files or other components of the image, as well as reviewing a virtual machine's configuration. A static inactive image of a virtual machine that is not executing as well as a dynamically changing image of an executing virtual machine may be viewed.

Automated Image Modification. Allows any file or folder in an image to be changed as if it were a mounted file system without causing the virtual machine to be executed or with the virtual machine being mounted or executing. The process may involve a script-based solution for file, folder, registry and/or other changes to the image. This allows the image to be changed reliably without breaking its integrity or requiring the presence of hypervisor support.

Manual Image Modification. Combining the Image Viewing and Image Modification capabilities leads to a manual image modification capability where the user directs all changes and edits to the image content.

Image Differencing Automation. Given two or more virtual machine images that originate from the same source or have independent histories, compare the images against each other and compute any or all of the following:

The differences among any subsets the images.

Any conflicts among sets of differences described above.

A script that will convert a set of images into new images based on differences.

A script that will combine the differences between sets of images, automatically resolve any conflicts and produce a new images distinct from the original images.

Any or all of the above differences and scripts done with respect to the native file or storage system of the virtual machine.

Any or all of the above differences and scripts done with structured data such as different forms of databases, structured and unstructured data, configurations, or programs.

Any or all of the above differences and scripts applies to registry settings, virtual machine configuration, virtual hardware settings, and any or all related information about the virtual machine or its data content.

Any or all of the above done without requiring the execution of the virtual machine.

Any or all of the above done while the virtual machines are executing.

Any or all of the above differences and scripts generated in either or both a human readable or computer readable format.

Image differencing can support change management, incremental backup, disaster recovery, failover in the cloud and could be used to coordinate manual configuration and customization actions with state changes in the VM.

Script

A sequence of instructions to some automation infrastructure to effect some change in a virtual appliance, virtual machine configuration, operating system, software application, software component, host computer, a database, a data set, or any other programmable entity to perform any task. Scripts may be expressed in many languages, many formats, and with varying syntax and semantics depending on its purpose. Scripts may be used for many purposes, including but not limited to:

Automation of requirements gathering.

Automation of configuration model generation.

Automation of configuration model validation against requirements.

Automation of virtual appliance construction, destruction, configuration, or any form of modification.

Automation of virtual appliance testing.

Automation of all management, monitoring, measurement, backup, recovery, re-configuration and other operations tasks.

Other automation or non-automation tasks

Automation

In order to speed up the processing of IT functions, automation may be used throughout the architecture of an embodiment. Automation may be the process of executing actions against a computer that would otherwise be done by a human. As used herein, the term “automation” can mean any or all of, but not limited to, the following:

Automatically driving a GUI or web user interface (WUI) with instructions that specify what actions to take against the GUI.

Automatically driving an application programming interface (API) from a script.

Automatically driving a remote connection such as RDP, VNC, Kaseya, etc.

Automatically generating any of the scripts described herein.

Automatically recording an automation script from a GUI or WUI being driven by a human for use in a later execution of that script.

Consolidating the execution of many scripts into a pre-configured virtual appliance.

Executing any of the above.

The ability to specify, execute, maintain, update and extend automation in a parametric/data driven/configurable manner.

Automatically deriving, controlling, etc. instructions of any form from a knowledge base, UI, user specification or other source.

A combination of any or all of the above

A combination of any or all of the above and manual steps

Knowledge Base

An information store (e.g., a database) that retains facts, data, rules, models, tokens, keywords, indices, cross-references, relationships, inter-dependencies, interactions, conflict indicators, configuration item definitions, actions, scripts, component hierarchies, expertise, programs, templates, images, best practices, and/or other knowledge about hardware, software, operating systems, applications or any other related item whether physical or virtual. Such a knowledge base may have the following features:

The ability to capture knowledge for extension of the knowledge base.

The ability to apply such knowledge base to such software and hardware management activities as configuration, deployment, testing, provisioning, monitoring, management, upgrades, disaster recovery, performance, security, etc.

The ability to specify in a parametric/data driven/configurable manner what information and in what form a knowledge base should contain.

The ability to structure any of the forms of information stored in such knowledge base according to an arbitrary aspect, including but not limited to, applicability, context, relationships, etc.

The ability to label and parameterize such structured information using different methods, including but not limited to tokens, useful words, indices, cross-references, etc.

A database schema or tables or other representation that describe the knowledge base.

A database schema or tables or other representation that describe the plug-ins included and using the knowledge base.

A set of databases or other representations automatically configured, generated, initialized, etc. based on the set of included plug-ins and their metadata, including meta-models and/or models.

Versioning support.

Migration support.

Support for generating access APIs.

Data access.

Model access.

Schema access.

A method for structuring, manipulating, processing and otherwise dealing with data and/or metadata.

Packaged Expertise

Certain embodiments of the invention may be implemented in various products. Some of these products, as well as some or all of their components, may use the knowledge base (described in part above) for their operations. This knowledge base may include knowledge captured directly or indirectly from different sources including, but not limited to, human experts, documents, documentations, other knowledge bases, web sites, databases, data, operations, etc. That knowledge may be tokenized and/or organized into plug-ins. The system of an embodiment may provide components for automatically or manually performing operations on that knowledge such as gathering, organizing, visualizing, modifying, applying, processing, importing, exporting, etc. A UI may be provided for all or some aspects of these operations. APIs may be provided for programmatic operations on the knowledge. Third party tools, software, data, and/or knowledge may be integrated with the system.

Tokenization

For simplification and abstraction purposes, a technique known as tokenization may be used in one or more embodiments. A token may be a term, keyword, unique identifier, or other simple and short textual data that stands for, refers to or indicates a more complex set of knowledge represented in the knowledge base. The process of tokenization is an automated or manual way of extracting meaningful tokens from the knowledge base or other information sources. A token-based approach means combining tokens in such a way that new meanings, actions, or understanding may be formed, related or executed.

Model Base

One or more embodiments may contain a “model base,” which is an information store that mainly contains various kinds of models. The model base may be characterized by any or all of the following:

A token-based specification of actions preferred, useful or needed to install and configure a product.

Creation and maintenance of a library of reusable keywords for configuring a product or other purposes.

A model-based approach to software configuration, testing and validation.

Creating a model for configuration of complex software including dependency information.

Annotating a model with configuration keywords to contain deployment and configuration information.

Annotating a model with test keywords to test the functionality of useful user scenarios.

Annotating a model with performance test keywords to test the SLAs of useful user scenarios.

Annotating a model with security test keywords to test the security of useful user scenarios.

The ability to create, maintain and utilize multi-level models that describe any aspect of the knowledge-base content as well as any aspect of its application.

One of the possible examples of these levels may include but may not be limited to:

Meta-models, that may be defined by the product, which defines all possible models expressible in the meta-model, which may be implemented in the product's code

Knowledge models, which may be defined by an expert external to the product, define all or some possible inputs, outputs, states, transitions among them, and ways to acquire, process, and output them, interpreted by a meta-model.

Model Input/Output/State/Execution, which may be, e.g., outcomes, or instantiations, or examples, or content, or derivative of the knowledge models and may have the following properties, provided by an end-user, acquired by following/executing/interpreting/etc a knowledge model:

The ability to specify, execute, interpret, input, output, etc. any of the aforementioned multi-level models in a parametric/data driven/configurable manner.

Meta-model describing relevant aspects of the UI and other components of the product that can be specified, e.g., operations, behavior, visualizations, interactions, relationships, inputs, outputs, transformations, etc.

A model, which conforms to the meta-model, and which specifies the desired aspects of the UI (as above).

A method for visualizing the meta-models.

A method for visualizing the models.

A method and/or format for specifying the models.

A method for manually or automatically modifying the models.

A method for verifying correctness of the models.

A method for simulating operations of the models.

A UI for specifying, verifying, simulating the models.

A method for detecting, showing, and correcting errors in the model.

A method for storing, retrieving, etc of the models.

A method for versioning the meta-models and models.

A method for updating meta-models and models with versions.

A method for different forms of executing of the models, e.g., interpreting, visualizing, simulating, translation, compilation, etc.

Generation, transmission, and storage of the outputs of the model execution.

Applications

One or more embodiments may consist of a number of interconnected applications. Applications may be functional and infrastructural components of a product or structure of a product, which may include the following features:

Applications may be composed vertically to provide functionality, e.g., testing, SLAs, configuration.

Applications may be composed horizontally to provide different stages of interactions, processing, computation, automation, etc.

Application infrastructure may consolidate shared parts and infrastructure among applications.

Application infrastructure may provide plugin/metamodel/model abstractions and frameworks to all components of all applications, horizontally and vertically.

As a result, all applications may be extensible through plugins/metamodels/models as described in the UI example (same principles apply to any aspect of any application or component).

Multi-layer component framework.

Communication APIs.

Plugin and metamodel framework.

Load/unload/link/execute support.

Message dispatching for different methods of communication.

Shared and individual databases/schemas/and DB connections.

User Interface

A user interface may be implied in all functional specifications of one or more embodiments. The implied user interface may be characterized by any of one or more of, but not limited to, the following:

Parametric/data-driven/configurable UI that allows dynamically changing the content, flow, presentation, and other aspects of any UI elements or behavior.

The above, role-based, i.e., each of the above aspects may be dependent on the role assigned to a given user interacting with the UI.

Automatically generating UI wizards from declarative specifications of any information preferred, useful or needed to configure a product (default values).

A UI that is model based, or knowledge based, or tokenized

A UI integrated with or driving a model based, or knowledge based, or tokenized functionality.

A specification method to implement the above.

The ability to automatically derive the above capabilities or specification based on existing information, e.g., user, account, content of the database, context, state of the UI or application, etc.

The ability to allow the designer/builder of an application to describe what information may be preferred, useful or needed to configure, deploy and manage their product, and have the parametric UI automatically generate a collection of wizards from same.

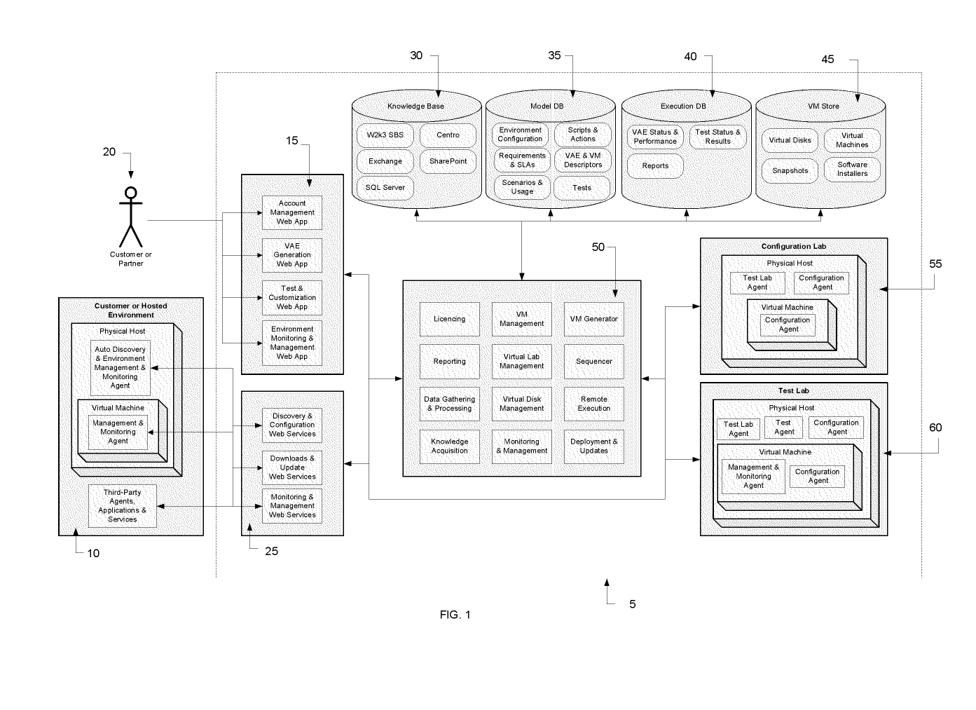

Referring now to FIG. 1, illustrated are the functionality, processes and technology associated with a system 5 (as delineated by dashed lines in FIG. 1), implementable in hardware, software, firmware, or combinations thereof according to one or more embodiments, as they pertain to providing services to a computing environment 10 of a customer. The illustrated system 5 includes a web application component 15, a web services component 25, a knowledge database 30, a model database 35, an execution database 40, virtual machine storage 45, a back-end component 50, a configuration lab 55 and a test lab 60.

As illustrated in FIG. 1, an embodiment enables the collection, or capture, of a specification of the customer's requirements that satisfies some purpose within the computing environment 10. In connection with such capture functionality, one or more embodiments provide parametric, data-driven, and/or configurable approaches to determining, with regard to the environment 10, what data, including, but not limited to, requirements, should be gathered from sources including but not limited to the customer or its representative IT expert, software or hardware, data sources, and automated discovery of network topology, software and hardware configuration and usage data. Such determinations can yield requirements for one or more virtual appliances useful to environment 10.

For example, an IT expert 20 acting on behalf of the customer may access, via a network-enabled computer (not shown), a GUI associated with a discovery web service function of one or more of the web application component 15 or web services component 25. Through use of this GUI, the expert 20 may provide some or all of the information (e.g., requirements) that will serve to define the services required for the environment 10.

Alternatively, or additionally, an automatic discovery agent may be dispatched by web services component 25 to the environment 10 to enable the aforementioned automatic capture functionality. In one or more embodiments, the automatic capture functionality includes the following features:

Automatically capture environment 10 requirements for software configuration, functional scenarios, performance scenarios, security scenarios, and capacity growth scenarios.

Automatically capture service level agreement (SLA) details associated with environment 10 for all the above scenarios, including but not limited to response time, number of users, workload processed per unit time, reliability, availability, failover, recovery, capacity growth, system and application resource utilization.

The ability to specify and operate on relationships (e.g., dependencies) among requirements or other data to be gathered.

The ability to specify and operate on relationships (e.g., dependencies) among requirements or other data to be gathered, and data or actions that depend on them or should be derived from them.

The ability to specify defaults for values including but not limited to parameters, relationships, dependencies, topologies, configurations, etc.

The ability to derive new data based on gathered data.

Configuration Extraction—Examination of a virtual machine's image to extract its hardware and software settings and generate the corresponding virtual hardware and software requirements into an XML document.

An embodiment automatically translates the customer's requirements for environment 10 into a configuration model of IT components and permits this configuration model to be adjusted. Once requirements for one or more virtual appliances have been gathered, a model of the appliances' configuration may be constructed using the knowledge database 30 which, in an embodiment, contains the following:

hardware requirements of operating systems, software applications and software components;

software component hierarchies for operating systems,

software applications, and software components;

software relationships and inter-dependencies;

construction rules to avoid interference, incompatibility, impedance mismatch, to be used when assembling a virtual appliance from individual software components;

software configuration items, their permitted value ranges and their effects on the software and on the values of other configuration items.

In an embodiment, multiple of the components may implement image management of virtual appliances, ranging from deployment, upgrades, differencing, modifications, backups, recovery, failover, and failback.

In an embodiment, the back-end component 50, in conjunction with the model database 35 and/or configuration lab 55, uses the foregoing knowledge database 30 items to translate requirements into a configuration model that specifies all components of the virtual appliance(s), with their configurations, preferred, useful or needed to satisfy the requirements.

Auto-detection of environment, its components, their configuration. The results may be used by other parts and functions of the platform. Such detection may involve using existing tools, available APIs and protocols, as well as other direct and indirect methods of detecting and identifying components, their configuration and status.

Automatic or manual conversion of such detected components into knowledge, models, or tokens.

Automatic or manual detection or creation of different versions of a component, sets of components or environments.

Trying out different versions of the environments, their components, and their configuration. Automated or manual, single or multiple versions.

To capture the configuration information of operating systems, applications, databases and other software components, a data format may be preferred, useful or needed. One possible data format prescribed for this purpose is an XML document with a specific Data Type Definition (DTD) expressed as an XML Schema. This DTD may be characterized by any of the following features:

Model Based. The elements of the DTD represent a model of the configuration information. ID/IDREF may be used to form linkages between the elements. The document schema has inherent knowledge at the meta-model level of various configuration items, such as:

registry settings: keys and values, including multiple values.

configuration file formats (e.g., .ini format, .yaml format, xml format, etc) and the ability to specify changes to the configuration data in a format-independent manner.

software components (DLLs, executables, logical sub-components).

virtual hardware components (networks adapters, disks, cpus, memory).

Data, databases, or other data sets, structured or unstructured.

Separation of Model and Configuration. The model of the configuration data specifies what values can be set (i.e., creates a dictionary of the configuration items). A separate portion of the configuration document specifies how those configuration items may be set.

Tokenized. Any configuration item can be tagged with a token word for cross-reference, indexing or other purposes.

Computational. Values for configuration items can be computed using simple arithmetic notation.

Conditional. Configuration items can be conditionally set using Boolean logic and arithmetic operators to determine the conditions under which a configuration item can be set.

Grouping. Sets of configuration items can be grouped together into logically related subsets.

Nesting. Groups of configuration items can be nested within each other to represent sub-groups.

Inference. There are natural relationships between configuration items, especially between ones at higher nesting levels and their subordinates. The schema may support a limited form of inference for specifying how to derive subordinate configuration items from their superiors. For example, a “Number of Users” configuration item might imply the number of virtual server machines, number of user accounts, and amount of memory preferred, useful or needed in the configuration.

Capturing configuration information can be a detailed process. The process of capturing this information may be characterized by any of the following features:

Visual Construction. XML is not particularly friendly to edit. In an embodiment, a tool may be provided to allow for visual construction of the configuration document. Links, relationships, formulas, nesting, and inference rules may all be entered and edited visually with a graphical user interface and/or web interface.

Saves Partial Results. It may not be possible to specify the full results of a configuration in one sitting. Users may need to come back to the configuration over a long period of time. One or more embodiments save partial results which can be continually revised.

Tool Integration. A capture tool integrates with several other tools, especially those that can extract information from existing registry entries, configuration files or other software constructs. It may include P2V tools for capturing a virtual image of an existing physical machine that is known to be configured correctly and then extracting the configuration of that virtual image by direct virtual disk access.

SDK. The capture tool comes with a software development kit that allows the XML-based configuration document to be constructed programmatically and facilitates the extraction of configuration data from a variety of sources.

Configuration Automation Capture and Refinement. Where applicable, the capture tool provides an environment for user-specific customization during the capture of configuration information. The tool can create a script based on the recorded steps taken by the user to configure software (run an installer, invoke a wizard, access the control panel, etc.). The first time this is done, the user steps will be automatically recorded. Once the automation scripts have been cleaned up (automatically or manually), future customizations will be done automatically by application of the automated script. Using this technique of capture and refinement, a complete configuration process can be derived simply by invoking the steps preferred, useful or needed to accomplish the configuration.

The configuration of software may be done with a particular usage scenario in mind. Configurations for small environments will not be suitable for larger environments, and vice versa. The configuration process can automate scaling, by utilizing the following process characteristics:

Scale Fact Knowledgebase. A static knowledge base of scale related facts may be consulted during the scaling process. This knowledge base may consist of known facts about the inter-relationships between levels of usage, hardware, operating system, and applications. The knowledge base may know absolute limits for configuration items, how configuration items interact, which values for configuration items to avoid, and other knowledge about configuration items.

Requirements-Based Goal Seeking. This process seeks to satisfy the goal specified by input requirements. Requirements may be such things as number of users, frequency of utilization, expected data volumes (e.g., 10 emails a day), availability SLAs, backup time granularity (e.g., daily, weekly, hourly, real-time), internationalization and localization requirements, etc. The process uses its known rules about these types of requirements and facts from the Scale Fact Knowledgebase to satisfy the goals of the requirements.

Evidence Based. one or more embodiments use actual performance data gathered from the existing configuration to assist in determining how much computing infrastructure will be preferred, useful or needed to satisfy the requirements.

Continual Refinement. As performance data is gathered from the running configurations, new scale facts may be added to the knowledge database 30. For example, the system 5 should automatically derive things such as the maximum throughput of email for a given Exchange Server configuration or similar such end-limit results.

An embodiment of the invention is configured to translate the configuration model into a functioning IT infrastructure, whether physical or virtual, including but not limited to virtual appliances and virtual environments. Before attempting to construct a virtual appliance from its configuration model, the model may be verified to ensure there are no internal conflicts within said model. Verification may be done by comparing the configuration model against known facts in the knowledge database 30 about configuration mismatches, incompatibilities, or any other information that may preclude the configuration model from being realized.

Based on the user requirements, the configuration model derived from those requirements, configuration tokens and the software dependency model of the knowledge database 30, a construction script can be automatically generated that specifies a complete manifest of the physical and virtual components, hardware requirements, settings, configurations and modifications preferred, useful or needed to realize the configuration model. The construction model may be an XML document of a specific schema suited to building a manifest for a virtual appliance. Subsequently, the construction script may be executed to create a new virtual appliance. Additionally, the virtual machine's hardware settings may be automatically reconfigured based on virtual hardware requirements specified in an XML document.

In an embodiment, a configuration agent associated with the configuration lab 55 may be implemented. For example, such an agent could read commands (or a script) from a network socket and execute them. This agent could run inside the virtual machine and receive such commands and scripts from a controller component associated with, for example, the back-end component 50. Command would allow registry entry modification, file modification, invocation of control panel applets and administrative functions of the OS or Application, driving those applets.

In an embodiment, the starting point for auto-construction could be a pre-constructed “stock” image of a virtual machine, such as may be associated with virtual machine storage 45, with a known configuration. Construction time may be reduced by finding a suitable stock image that contains nearly the same (or identical) configuration as the desired target and using that stock image as the starting point for execution of the construction script (with the redundant portions eliminated).

One or more embodiments are configured to automatically generate and execute an automated test harness (including test plans, test scripts, test functions, etc.) that validates the behavior of the constructed infrastructure against the end user's requirements for environment 10. Such a test harness validates behavior that includes, but may not be limited to: functional, performance, capacity, scalability and security factors. One or more embodiments analyze the results to determine suitability of the appliance for deployment.

One or more embodiments include processes and technologies, as implemented in the test lab 60, for ensuring that the automatically generated virtual machine configurations are suitable for use in the environment 10. The automated testing strategy employed using test lab 60 may be characterized by one or more of the following:

Requirements Based. The same requirements used in the automated configuration and construction of a virtual appliance, as discussed above herein, may be used for testing that appliance.

Software Dependency Model. The model database 35, which may provide a model of the dependency relationships between software components, may be used to determine which functional areas may be addressed by the testing.

Functional Usage Scenarios and Tokens. The model database 35, which may provide functional usage scenarios for each software component, may be consulted to derive the set of functional tests to cover. Tokens may be used to link the functional usage scenarios with the functional tests to be executed.

Automated Test Script Generation. Based on creating the foregoing, a test script may be generated that automates the testing of the virtual appliance(s).

Automated Test Script Execution. The above-mentioned script may be applied to the generated virtual appliances by building on top of existing virtual appliances in a virtual test lab 60 environment to validate that the appliance(s) will meet the user requirements of functionality, performance and quality.

Automated Test Data Generation. When executing a test script, test data may be preferred, useful or needed in order to send something useful to the applications and operating systems being tested. Because requirements were captured and available in an automated fashion and because there may be a knowledge base about such applications and operating systems, the data preferred, useful or needed by the application for each test script may be automatically generated and provided to the test script as it is preferred, useful or needed (just-in-time data delivery).

Automated Test Criteria Generation: test conditions, whether initial, transient, or terminal as well as validation conditions whether passing or failing.

Broad Applicability. The processes described above may also be utilized for multiple dimensions or categories of requirements on the virtual appliance(s).

Those categories include, but may not be limited to:

performance and SLAs

performance testing and SLA measurement

security requirements

security testing and measurement

scalability requirements

compliance with standards, procedures, processes, or otherwise specified or named sets of requirements.

Test Knowledgebase. The aforementioned processes yield automated test scripts that may be captured in a knowledge base, such as model database 35 and/or execution database 40, in such a way that derivations of the test scripts (through slight alterations of the requirements) may easily be obtained. This test knowledge base may also store the original and derived test cases as individual testable items with linkage to the requirements the test item helps to verify.

Parameterized. Where feasible, test scripts generated by the above processes may be composed of discrete test items that may be parameterized, data driven or configurable. Such parameterized test items can be extracted from the knowledge base, based on requirements needing to be satisfied, and re-used with varying parameters for additional purposes.

Token Based Test Scenarios. Test scenarios may be specified using a token-based approach from which test cases may be automatically generated based on using the aforementioned capabilities.

Test Case Management. In an embodiment, the back-end component 50 may be configured for finding, creating, composing, editing, deleting, managing and executing test scenarios, test cases, test data, and test reports.

Automated Retesting Of Migrated Data. When any data or software is migrated, such as to environment 10, the applicable test cases may be automatically re-run to validate that the data or software has been successfully migrated to its new location.

Automated Capture Of Virtual Appliance Customizations. When customizations to a virtual appliance are made in the virtual test lab 60, those customizations may be automatically captured and incorporated into the configuration model and construction script(s) so they do not need to be re-applied should the virtual appliance need to be re-generated. For example, user actions or state changes or UI actions or API calls may be automatically or manually captured.

Once validated, one or more embodiments automatically distribute the constructed infrastructure to the end user's chosen computing environment 10, whether physical or virtual, and whether hosted, purchased or existing. Once distributed, one or more embodiments deploy the constructed infrastructure to the chosen computing environment, making it ready for execution. Once deployed, one or more embodiments provision the infrastructure for execution within the context of the computing infrastructure upon which it may be deployed.

After validating the operational readiness of a virtual appliance, it may be deployed from the virtual test lab 60 to the target operational environment 10. The deployment process, as implemented by, for example, back-end component 50, may be characterized by one or more of the following features:

Internet Delivery. An efficient mechanism for the delivery of virtual appliances either chosen from a library or constructed via P2V technology. All discussion herein pertaining to configuration also apply to partial and incremental changes to the customer's operational site over the internet. Compression and differencing techniques may be used to minimize the bandwidth utilization and speed the delivery of the appliance to its destination.

Media Delivery. The deployment can be accomplished through the delivery of an automated installer on a data medium. Media forms include files, databases, compressed or zipped files, DVD, CD, CD-ROM, recordable memory, re-recordable memory, flash, network media, wireless media, TCP/IP packets, FTP, and HTTP,

Any Execution Location. Distribution of any technology associated with one or more embodiments covers access to that technology regardless of the access point or location of execution of the technology, worldwide.

Pre-installed Delivery. In situations where the customer will deploy the virtual appliance onto new hardware, it can be arranged whereby the hardware supplier pre-installs the virtual appliance before delivery of the equipment to the customer.

Hosted Delivery. In situations where the customer wishes to utilize a hosting service for the equipment preferred, useful or needed to run the virtual appliance, it can be arranged whereby the hosting provided to install the virtual appliance before the hosted equipment is turned over to the customer.

Version Migration. When new versions of the operating system, applications, or virtual machines that comprise a virtual appliance are available, the system 5 can assist in migration of both the software and the customer's data to the newer version. The same configuration and validation techniques as described above may be used to validate that the software continues to function correctly after version migration.

Optimized Image Transmission. When upgrading a customer's software or configuration to a new version, transmission of the entire image (many GB) to the customer through the Internet may be too costly or time consuming if performed without some optimization. To optimize such transmission, a protocol, for example, based on the UNIX rdist protocol may be used to ensure that the deltas (i.e., new data) are transmitted and that the deltas are sent in a compressed fashion. A software agent on the receiving (customer's) end of the communication coordinates the update including the ability to roll-back in case the transmission fails before completing. The agent may for example be based on the rdist daemon but also includes functions for ensuring the image is shut down before the delta is applied and to capture any local changes made that may also be applied after the delta.

One or more embodiments may be configured to capture measurements from the executing infrastructure to measure functional health, performance, capacity, security, etc. One or more embodiments may be configured to automatically review measurements captured from the executing infrastructure, analyze the meaning of those measurements to determine if corrective actions need to be taken and either automatically take those actions or notify the infrastructure's owners/operators of the recommended corrective action.

Once a virtual appliance has been configured and tested to validate that it meets requirements, the virtual appliance may be ready to be put into service. During its service lifetime, the virtual appliance should be monitored to ensure that it functions within the allowed operational parameters; and, when it doesn't, that appropriate notifications are made. To accomplish this, the system 5 may use one or more of the following processes and technologies, as may be implemented in the back-end component 50:

Automated Alert Instrumentation. Based on user requirements of configuration, functionality, performance and security, automatically instrument the virtual appliance to generate alerts within the environment 10 when these conditions are not being met.

Remotely Monitored SLAs. Optionally, the virtual appliance may be remotely monitored (e.g., at a site remote from environment 10 chosen by IT expert 20) to ensure that it is performing within the preferred SLAs. Such SLAs may be derived from the appliance's original requirements and configuration. Interventions by trained personnel, such as expert 20, responding to SLA events can lead to additional playbook extensions as described above and further reducing the impact of availability or performance events.

One or more embodiments may be configured to provide command and control capability to start, stop, pause, customize, re-configure, optimize, resize, scale, migrate, consolidate, replicate, backup, recover, load balance or otherwise remotely manage the execution and operation of the infrastructure.

Once a virtual appliance is in a production environment 10 (processing real, live work load), and being monitored, the system 5 provides an automated management capability to ensure the operational health of the appliance in an on-going fashion, preferably using one or more of the following processes and technologies:

VM Control. Automated virtual machine boot, resume, suspend, and shutdown

Automated Maintenance Tasks. Automated initiation of management scripts at regular intervals for change capture, backup, health checks, log scrubbing, index rebalancing and other routine maintenance tasks.

Operational Playbook. A structured response guide for each application specifying what actions to take in case the pre-instrumented alerts are generated. This response guide may be referred to as a playbook. It may be derived from both the operational knowledge of the software as well as its configuration and test results.

Root Cause Analysis. Alert instrumentation and CMDB may be leveraged to rapidly pin-point the root cause of an alert being generated. The changes recorded in the CMDB become an audit trail of suspect (i.e., likely) configuration changes that can manifest specific kinds of alerts. Pairing the two sources of information leads to identification of the source of the problem and often the prescription for restoring normal function.

Recorded Manual Intervention. When manual intervention is required to restore normal function of the system, the actions taken by the operator in response to an alert may be automatically recorded. The recorded changes may be converted into a script that can be executed again should the symptom (alert) reappear.

Playbook Extension. When the operator clears an alert by running a script generated from a manual intervention, the management system responds by adding the item to the playbook. From then on, the triggering event will cause the automated execution of the script that resolves the problem.

All and any of the above may leverage the knowledge base, plugin architecture, tokens/tokenization, automation, and results and effects thereof

One or more embodiments may be configured to automatically and remotely apply patches, updates, version upgrades, optional functional, components, internationalization and localization components or any other changes that affect the behavior of the executing infrastructure. One or more embodiments may be configured to apply such changes in a verified manner such that changes may not compromise the original end user's requirements but only extend the functional capability of the executing infrastructure.

A software package may be comprised of several types of information:

Code—The executable software whether it is in compiled (DLL, EXE, COM) format or in an interpreted language (e.g. Java, .NET, Python, Ruby). In almost all applications, the code is static. That is, it doesn't change for the life of the application except upon upgrade.

Static Data—Non-executable static information that is installed and used by the software but not modified throughout the life of the application.

Configured Data—Non-executable static information that may have several different versions based on the configuration of the application. For example, files supporting internationalization and localization would be considered configured data.

Dynamic Data—Non-executable information that is created, manipulated, or otherwise modified by the software as a direct result of its use. For example, a SQL Server database or Word document fall into this category.

The above types of information may need to change for a variety of purposes:

Hot Fix—critical or important fixes to the system or application software may need to be applied periodically.

Version Upgrade—a new version of the software may need to be installed.

Configuration Change—the end user may elect to re-configure the application or operating system to meet changing requirements.

To facilitate these kinds of changes to the software, one or more embodiments optionally deploy one or more of the following processes and technologies:

CMDB. The virtual appliance's configuration changes may be stored in an online configuration management data base (CMDB) for tracking the original and continuing configuration changes made to the operational appliance.

Code/Data Separation—Each datum installed by the application may be tracked and categorized as above. Where applicable, the data from the first three categories (above) may be placed in one storage location while the Dynamic Data is located in a separate storage location. This facilitates the upgrade and data migration processes because Dynamic Data changes can be avoided or skipped.

WMI Change Capture—In order to apply patches to software (hot fixes, service packs, etc.) to a customer's image, the software should not disturb the customer's data unless it needs to be migrated to a new format (which the new software would do). Separating the system and application software from the data may be insufficient since it may not be immediately apparent which set of files are modified by the system or application, or for what purpose. To overcome this issue, the system or application may be instrumented with WMI, or direct Win32 API instrumentation, to determine which data is modified by that system or application. This instrumentation keeps a manifest of the files that may need to be migrated when the software is upgraded. This technique may also be used during initial installation of software to get a manifest of the items changed by the installer. Tracking changes with WMI may survive reboot so that deferred changes (requiring a reboot) can also be captured.

Write Interception—this technique, often used by spyware detection programs, may be used to log and track the changes made by the end-user, application or operating system. The list of changes made could be used to both eliminate anything that has not changed as well as validate which information has changed.

RDP Capture/Replay. Some configurations may be done through the installer or system user interfaces. Since RDP is based on replay of GDI operations, it may be possible to capture RDP data streams as a user is installing software and then replay that stream back to another instance at a later time. To ensure the RDP data stream effects the same set of configurations on the target machine as on the source machine, several extensions may be utilized:

The stream could be augmented to include contextual information such as operating system version, system 5 configuration ID, application versions, virtual machine configuration, etc.

Differences between the source machine and target machine (such as screen size, window position, operating system version difference, etc.) may be accommodated by modifying the RDP data stream on-the-fly as it is replayed to the target machine.

Extraneous (un-related) events may be filtered out.

Window titles may be verified to make sure that events being replayed are being sent to the correct window.

Periodic Difference Capture—accumulations of changes may be periodically captured and transmitted to a secure facility incorporated by or accessible to system 5 for archival purposes. When such changes indicate configuration changes, the customer's configuration information (originally captured via a web site associated with system 5) may be automatically updated in such a way that the changes are tracked and time stamped for easy roll-back to prior configuration versions, as described in greater detail below.

Software Update Validation. While facilities such as Microsoft Update™ make it easy to keep a system up to date, blindly accepting all updates can lead to system instability or unfamiliar software. To ensure that software updates do not affect the operational viability of a virtual appliance, the software upgrades may be applied in the virtual test lab 60 to validate that the system works based on user's requirements and with the user's configuration and data. When such updates pass the original software validation suite it may be approved for update on the appliance. One or more embodiments may be configured to take this cleaned up script and store it in the knowledge database 30 so it can be re-used with other actions and alerts.

One or more embodiments may be configured to automatically capture, transmit and store point-in-time copies, shadow copies, alternate configurations, etc. of the executing infrastructure for archives backup, recovery, fail-over or other operational readiness concerns. Image differencing may be used to determine the changes made to a virtual machine image for the purpose of reducing the amount of data needing to be archived. Change management techniques, described above, may also be used to reduce the amount of data needing to be archived. Each capture of the accumulated changes becomes a potential rollback target that provides recovery from data loss, mis-configuration, improper software update, etc. The captured periodic differences in the customer's system may be rolled forward on a comparable virtual appliance (either locally or hosted) and placed in service to effect a failover from one (failed) host to another (working) host. Optionally, a redundant system can continually roll changes forward to the VM image as they occur in real time. This provides a “hot failover” capability that provides a ready-to-go VM image that can be started within seconds of the failure of the primary system.

One or more embodiments may be configured to support a plug-in API for third-parties to write data-migration plug-ins based on models and keyword-accessed knowledge and scripts. One or more embodiments may include an authoring environment for UI wizards, model creation, and useful word generation for functional, performance and security keywords.

One or more embodiments may include an Application Development SDK (Software Development Kit) that helps ISVs (Independent Software Vendors) construct software applications that conform to the functionality of system 5. The SDK provides facilities to application developers to make integration with the system 5 much easier. Such an SDK provides support for:

Capturing the set of configuration options, configurable data, registry entries, etc. applicable to the ISV's software that may preferably be, or need to be auto-configured by the system 5.

Capturing test requirements, readiness tests, test code points, etc. for verification of the application's health in various configurations.

Assisting with software upgrades, data migration, reconfiguration, and scaling tasks for the ISV's application software.

Providing a library of functions for simple integration with the monitoring and management infrastructure of the system 5.

Assisting with separation of the application's code, configuration and static data from its end-user data and integration with the system 5 for managing the steps in these tasks.

Generation of XML documents preferred, useful or needed of the system 5 for the automation of the application's installation, configuration, testing and management.

A method for loading and linking plugins and making them operational within the system 5.

A method for specifying different aspects of plugins, including but not limited to their operations, behavior, relationships, components, inputs, outputs, etc.

Infrastructure that automatically monitors, registers, loads, unloads, executes, connects, provides data for, runs UI for, feeds inputs, captures outputs, and connects with database for plugins

Metadata for plugins providing a way to specify, calculate, process, etc. information about plugins.

A database of plugin metadata.

Generic schema for plugin metadata, plugin metamodels, models, inputs, outputs, etc.

A mechanism for tracing execution of plugins including their models.

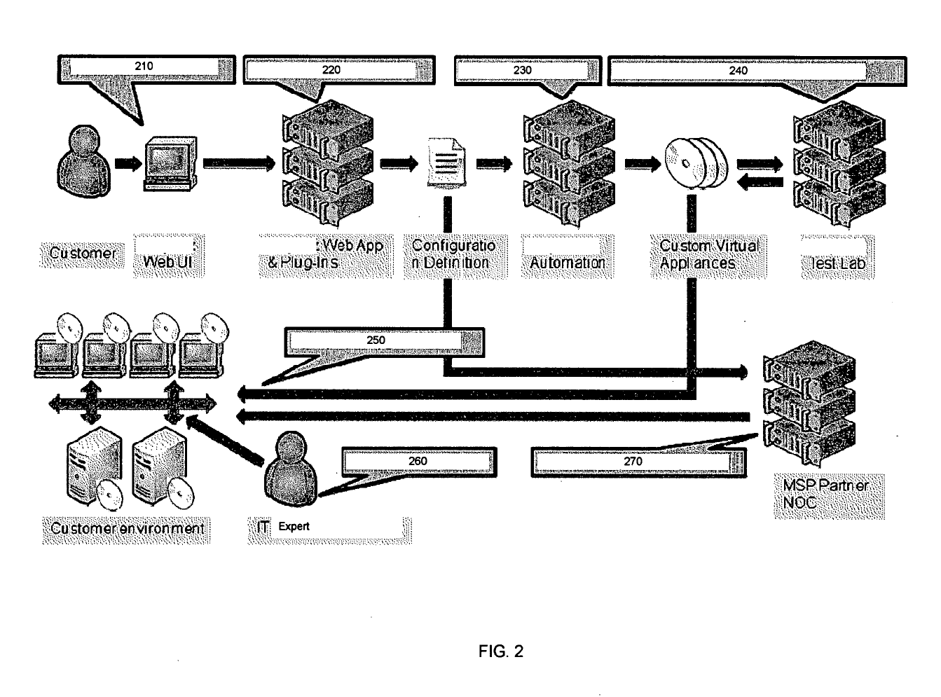

Referring now to FIG. 2, illustrated is an exemplary process flow of aspects of the above-described functionality. The illustrated process flow may be fully automated by hardware, partially automated by hardware, fully automated by software, partially automated by software, performed manually by a human, or performed using any combination thereof. The order of the steps described is not to be construed as a limitation.

At a step 210, requirements for a computer environment 10 are gathered through a guided UI, forms, xml documents, excel spreadsheets, other sources of data or scripts, and/or auto-detection of customer's environment. Such determinations can yield requirements for one or more virtual appliances useful to environment 10.

At a step 220, a desired virtual-appliance configuration based on the gathered requirements is determined. For example, an embodiment automatically translates the customer's requirements for environment 10 into a configuration model of desired IT components for such environment, and permits this configuration model to be adjusted. As such, once requirements for one or more virtual appliances have been gathered, a model of the appliances' configuration may be constructed using, for example, the knowledge database 30.

At a step 230, one or more virtual appliances of the determined configuration are generated starting from one or more of an empty VM, a pre-configured virtual appliance selected from a library of virtual appliances, a pre-configured virtual appliance generated from a physical device using a Physical2Virtual converter or a pre-configured virtual appliance provided by a third party vendor.

At a step 240, and using, for example, the test lab 60, the functionality, performance, reliability, availability, scalability, and/or security of the virtual appliances are tested. Validation that SLAs and other requirements are met is also achieved. Further, the virtual appliances may be customized for the end user's environment and context. For example, one or more embodiments are configured to automatically generate and execute an automated test harness (including test plans, test scripts, test functions, etc.) that validates the behavior of the constructed infrastructure against the end user's requirements for environment 10. One or more embodiments analyze the results to determine suitability of the appliance for deployment.

At a step 250, the virtual appliances are deployed, upgraded, patched, reconfigured, and/or migrated. For example, after validating the operational readiness of a virtual appliance, it may be deployed from the virtual test lab 60 to the target operational environment 10.

Additionally, at the step 250, an externally created virtual appliance can be imported into the Test Lab and integrated with the remaining functionality.

Additionally, at the step 250, image management in the form of backups, restores, deltas, differences, upgrades, mobility, failovers, failbacks, etc. may be performed.

At a step 260, other support operations required in the ongoing operation of the virtual appliances may be provided. For example, when new versions of the operating system, applications, or virtual machines that comprise a virtual appliance are available, the system 5 can assist in migration of both the software and the customer's data to the newer version. The same configuration and validation techniques as described above herein may be used to validate that the software continues to function correctly after version migration.

At a step 270, the virtual appliances are monitored and managed, as discussed above herein.

All the steps described above with reference to FIG. 2 may be performed across multiple copies of a customer environment or its components such as, for example, for a distributed environment, one that includes third party hosted components, or failover or failback components.

All the steps above may be performed across multiple copies of embodiment systems, e.g., if it is replicated across multiple sites or if its components are distributed or replicated.

State-Based Functional Automation

One or more embodiments may be configured to use an innovative approach to functional automation. Instead of treating the automation as merely a sequence of steps, an embodiment treats the task of automation similar but not limited to what a human would do, by monitoring the state of the user interface and other observable or historical data, and responding to what it finds based on recognized patterns.

A computer user interface according to an embodiment is comprised of a variety of UI elements. Some or all of the elements may be organized in a tree-like structure (e.g., a window may open a dialog, in which case the window is a parent of the dialog) and the structure may be readable or otherwise recognizable to the embodiment. Terminal nodes on such a tree would therefore comprise a recognizable and unique state of a given user interface. If such structure is not completely available, the available subset may be used and the embodiment may organize the remaining components according to its internal rules.

One or more elements of system 5, such as, for example, web application component 15 and/or web services component 25, receives as input a list of such states, where each state uniquely defines an element on a screen complex enough to be uniquely identified (e.g., window, form, dialogue, etc.) whether by its placement in the element tree hierarchy or by other means (e.g., elements it itself is comprised of, its attributes etc.).

Each state has associated therewith predetermined operations to be performed when such state is encountered. The system 5 continuously analyzes all elements of the user interface on a computer screen in an attempt to match those elements against known input states. When a known state is encountered, the system 5 performs as an output the steps associated with that state.

Error steps and unexpected steps may be detected.

Feedback from a user may be incorporated dynamically at execution time.

Multiple concurrent automations may execute at the same time.

Automation may be extended by adding states and steps even at run time.

Such approach is inherently less susceptible to external interference and is therefore more robust.

Such approach is not limited to the states represented by the structure and inputs and may be combined with other sources of information and actions, e.g., sequences of states, history or content of components, etc.

In a hybrid approach, state based and sequence based actions may be mixed.

Disaster Recovery

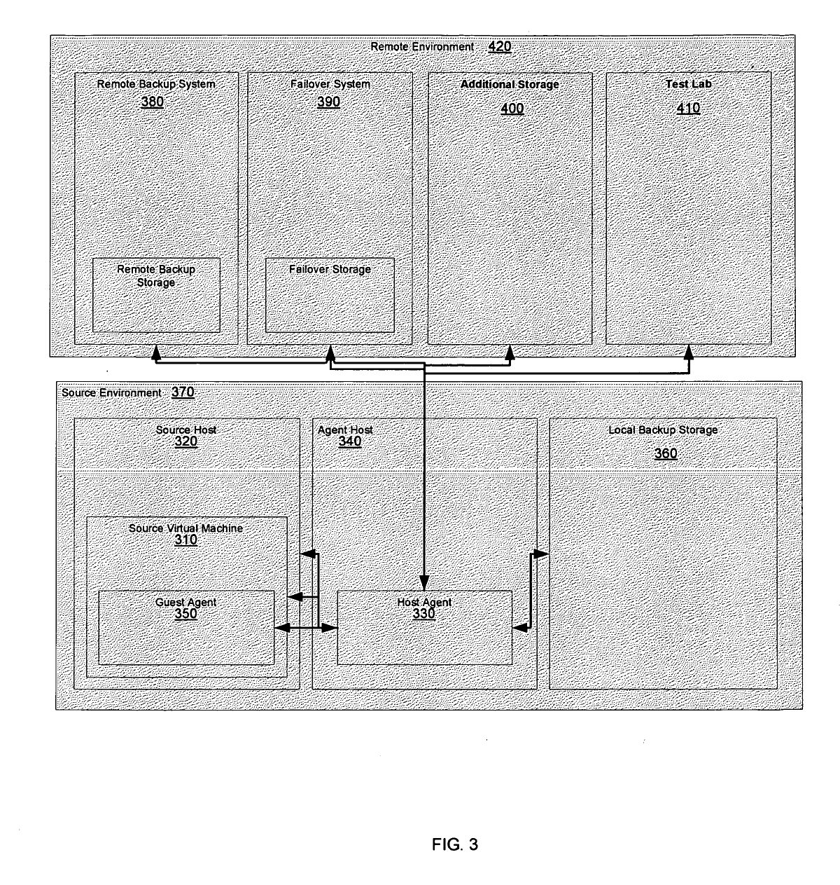

Referring now to FIG. 3, a functional block diagram illustrates a disaster-recovery approach according to an embodiment. The illustrated approach may be fully automated by hardware, partially automated by hardware, fully automated by software, partially automated by software, performed manually by a human, or performed using any combination thereof. The order of the steps described is not to be construed as a limitation.

The embodiment illustrated in FIG. 3 may include, but is not limited to, some or all of the following components:

Source virtual machine 310—the virtual machine under the embodiment's disaster recovery system. There may be zero, one, or more source virtual machines 310 in one or more embodiments.

Source host 320—where the source virtual machines resides. There may be zero, one, or more source hosts 320 in one or more embodiments. Each source host 320 may have zero, one or more source virtual machines 310 on it. Each source host 320 may have virtual machines on it that are not source virtual machines 310.

Host agent 330—the part of the embodiment, which among other functions, performs backup, recovery, failover, and failback operations on source virtual machines 310 and source hosts 320. A host agent may use and operate on additional virtual machines or hosts as well. A virtual machine is associated with a host agent 330. A host agent 330 may manage more than one source virtual machine 310 and more than one source host 320. A source virtual machine 310 may be managed by more than one host agent 330. A host agent 330 may be a virtual machine or a physically deployed instance.

Agent host 340—where the host agent 330, which manages one or more of the source virtual machines 310 resides. A host agent 330 may be placed on a machine that is not a source machine or one that is, i.e., an agent host 340 may be the same as a source host 320 or separate from it.

Guest agent 350—the part of the embodiment that resides inside a source virtual machine 310 or any other virtual machine. If the guest agent 350 resides inside a source virtual machine 310, among other functions, it may participate in the disaster recovery functions of the embodiment.

Local backup storage 360—any form of storage, e.g., external disk or array of disks or a file system exported by a server, which is used by the embodiment for storing local copies of images, snapshots, and other data used by the embodiment's disaster recovery system.

Source environment 370—includes source hosts 320, agent hosts 340, local backup storage and all the physical and virtual machines and data on them, including host agents 330 and source virtual machines 310. The source environment 370 may consist of, be a part of, or may otherwise be accessible to the system 5 illustrated in and discussed with reference to FIG. 1. The embodiment may support one or more source environments 370.

Remote backup system 380—the part of the embodiment that performs all the remote backup and recovery operations and stores and manages remote copies of images, snapshots and other data used for these operations.

Failover system 390—the part of the embodiment that performs all the remote failover, and failback operations and stores and manages remote copies of images, snapshots and other data used for these operations.

Additional storage system 400—the part of the embodiment, which stores additional copies of images, snapshots, and other data, for the purposes of backup, restore, failover, or failback. The data in the additional storage 400 may be replicas of the data in the remote backup or failover systems, additional versions of the data, e.g., older or intermediate versions, as well as versions of the virtual machines that do not exist in the other ones.

Test Lab 410—the part of the embodiment, where virtual machines can be executed separately from their source environment, e.g., in order to validate their state, test them, or modify them.

There may be zero, one, or more copies of remote backup system 380, failover system 390, test labs 410, and additional storage systems 400 in the embodiment.

Each copy of the remote backup system 380, failover system 390, test lab 410, and additional storage system 400 may store and manage the same or different data or mixture thereof.

Copies of remote backup system 380, failover system 390, test lab 410, and additional storage system 400 may be collocated or geographically distributed.

Remote environment 420—includes remote backup system 380, failover system 390, test lab 410, and additional storage 400 and other parts of the embodiment involved in implementing of disaster recovery that are not a part of the source environment 370. The remote environment may be coupled to the source environment 370 over a network, such the Internet, an LAN, or other arrangement.

There are many ways of adding virtual machines to the system, among them:

A physical machine may be converted to a virtual machine through a P2V (physical to virtual) conversion and placed on a source machine 310.

A backup of a physical machine may be converted to a virtual machine through a restore to virtual machine process and placed on a source machine 310.

An arbitrary full or partial representation of a software system may be converted into a working virtual machine through a combination of manual or automated steps and placed on a source machine 310.

A virtual machine may be migrated from a virtualization platform (hypervisor) not compatible with the embodiment onto one that is compatible with it and placed on a source machine 310,

A virtual machine may be transferred from other components of the embodiment onto a source machine 310. Such virtual machine may have been added to the embodiment through one of many available ways of creating, modifying, or importing virtual machines into the embodiment.

Snapshots of Virtual Machine Images

An initial full snapshot of the virtual machine's image is taken.

An additional full snapshot of the virtual machine's image is taken.

An incremental snapshot is taken as a delta from a full snapshot or an incremental snapshot.

Incremental snapshots may be taken at multiple granularities at the same time.

Incremental snapshots may be taken from multiple different full or incremental snapshots at the same time.

Full snapshots may be taken independently of incremental snapshots and vice-versa.

Processing Snapshot Images

Snapshots may be captured as or converted into differences between two or more preexisting and new images.

Snapshots may be captured as or converted into full images.

One or more incremental snapshots may be collapsed into a fewer number of incremental snapshots thereby becoming higher granularity bigger difference snapshots.

One or more incremental snapshots may be collapsed and fully absorbed into a full snapshot.

Some of the incremental and full snapshots may be deleted from the system.

Incremental snapshots may be computed as a result of differencing two or more existing incremental or full backups.

Additional differencing and transformations may be performed for optimizing any of the embodiment's functions or implementing additional ones.

Snapshots, their differencing, transfer, processing, etc. can be based on underlying infrastructure (e.g., hypervisor) supported snapshots, as binary representation based off of the underlying infrastructure (e.g., hypervisor) representation of a file system or image, internal virtual machine file system (e.g., Windows), a custom binary representation.

Transfer of DR Data

DR data includes images, snapshots and any additional data used by the embodiment's disaster recovery functionality.

DR data may be uploaded from a source environment 370 to the remote environment 420 in part or whole, eagerly or lazily.

DR data may be downloaded from a remote environment 420 to a source environment 370 in part or whole, eagerly or lazily.

DR data may be transferred by electronic means as well as by means of external physical media, e.g., external hard disks, USB drives, DVD ROMs, etc.

DR data may be sent to a single destination or it may be multicast or broadcast to multiple destinations.

DR data may be compressed, differentiated, or otherwise transformed for the purpose of the transfer and other functions.

Disaster Recovery functionality of the embodiment may be adjusted to different sets of requirements, for example, of a specific source virtual machine 310, source environment 370, or the entire embodiment.

Frequency or schedule at which different times of backups are taken.

Transfer, storage, differencing and other sizes.

Granularity at which snapshots are captured.

Collapsing policies, including schedule, frequency, reduction rates, etc.

Retention policies including schedule, frequency, sizes, etc.

Storage management on the source.

Storage management on the target.

Multiplicity of copying at different levels.

Any parameters of disaster recovery may be computed based on the history or state or other characteristics of a source virtual machine 310, source environment 370, remote environment 420, or a set thereof.

Any parameters of disaster recovery may be computed based on the user provided requirements for any aspects of a source virtual machine 310, source environment 370, remote environment 420, or a set thereof.

Disaster Recovery functionality of the embodiment supports among others the following usage scenarios:

Full backup, whereby the entire image is captured.

Incremental backup, whereby a difference between two images is captured.

Local file-level restore, whereby any, all, or some files may be recovered from DR data residing in the source environment 370.

Local virtual machine level restore, whereby an entire virtual machine may be recovered from DR data residing in the source environment 370.

Local failover, whereby a version of a virtual machine is restarted in a source environment 370 after being recovered from DR data residing in the source environment.

Remote file-level restore, whereby any, all, or some files may be recovered from DR data residing in the remote environment 420.

Remote virtual machine level restore, whereby an entire virtual machine may be recovered from DR data residing in the remote environment 420.

Remote failover, whereby a version of a virtual machine is restarted in a remote environment 420 after being recovered from DR data residing in a remote environment.

Failback from a remote failover, whereby a version of virtual machine is restarted in a source environment 370 after being transferred from a remote environment 420 where it was remotely failed over.

Backups can be made of the machine running in a failover state just like one running in a source environment 370.

Deltas can be sent among any parts of the embodiment to be integrated into and restored and used as new versions of a virtual machine.

A virtual machine is restored from a backup in the test lab 410 for testing or modification.

Results of testing and modification as sent to the source environment 370, restored and restarted as a new version of the virtual machine.

For the purpose of the above list, one source environment 370 may serve as a remote environment 420 for another source environment or it may be treated as a part of that source environment.

An example of steps involved in disaster recovery:

A virtual machine is added to the system.

Local backup storage 360 is configured.

A full backup is taken of the virtual machine.

Additional incremental backups are taken of the virtual machine.

A backup is processed, validated, and stored in the local backup storage 360.

A backup is processed and transferred to the remote environment 420.

A backup is transferred to the remote environment 420 is validated and stored.

A reverse backup is transferred to the source environment 370, validated, and stored.

An incremental backup is collapsed in either remote 380 or local backup storage 360.

A virtual machine image is reconstructed based off a snapshot.

A restored virtual machine image is mounted to gain access to its content.

A restored virtual machine image is started in the test lab 410 for modifications or testing or other purposes.

A restored virtual machine image is started for failover or failback.

Some actions that may be undertaken manually or automatically in order to obtain cleaner snapshots.

Log any users out of the system.

Shut down all applications.

Shut down all non-essential services (MSSQL, Exchange, etc.).

Shut down all essential services that are not needed for the full backup (e.g., only disk and network services may be needed).

Manipulate data, applications, system, and configuration of the source virtual machine 310.

The process may apply to entire virtual machine images as well as parts of them, e.g., including only a subset of the disks or excluding some of their content.

The process may apply to virtual machines that are generated internally by the system as well as imported from the outside of the system.

While a preferred embodiment has been illustrated and described, as noted above, many changes can be made without departing from the spirit and scope of the preferred embodiment. Accordingly, the scope of a preferred embodiment is not limited by the disclosure of the preferred embodiment. Instead, a preferred embodiment should be determined entirely by reference to the claims that follow.

1. A system comprising at least one computer-executable module configured to:
collect a specification of the end user's requirements that satisfies some purpose within a computing environment;
automatically translate the end user's requirements into a configuration model of IT components, permitting this configuration model to be adjusted;
translate the configuration model into a functioning IT infrastructure whether physical or virtual;
automatically generate and execute an automated test harness, including at least test plans, test scripts, test functions, that validates the behavior of the constructed infrastructure against the end user's requirements, such a test harness validates behavior that includes, but may not be limited to functional, performance, capacity, scalability and security factors, analyzing the results to determine suitability of the appliance for deployment;
once validated, automatically distribute the constructed infrastructure to the end user's chosen computing environment whether physical or virtual, and whether hosted, purchased or existing, once distributed, deploy the constructed infrastructure to the chosen computing environment, making it ready for execution, once deployed, provision the infrastructure for execution within the context of the computing infrastructure upon which it may be deployed;
capture measurements from the executing infrastructure to measure functional health, performance, capacity, security, automatically reviewing measurements captured from the executing infrastructure, analyze the meaning of those measurements to determine if corrective actions need to be taken and either automatically take those actions or notify the infrastructure's owners/operators of the recommended corrective action;
provide command and control capability to start, stop, pause, customize, re-configure, optimize, resize, scale, migrate, consolidate, replicate, backup, recover, load balance or otherwise manage the execution and operation of the infrastructure;
automatically apply patches, updates, version upgrades, optional functional, components, internationalization and localization components or any other changes that affect the behavior of the executing infrastructure, apply such changes in a verified manner such changes may not compromise the original end user's requirements but only extend the functional capability of the executing infrastructure;
automatically capture, transmit and store point-in-time copies, shadow copies, alternate configurations, of the executing infrastructure for archive, backup, recovery, fail-over or other operational readiness concerns; and
automatically document the requirements, specifications, configuration, options manifest, test results, operational history, change history, event history and all other aspects of the infrastructure from the point of construction to the end of its operational lifetime.
